(19) United States
(12) Patent Application Publication
(10) Pub. No.: US 2019/0108779 A1
(43) Pub. Date: Apr. 11, 2019

(54) PROJECTION APPARATUS AND METHOD OF CONTROLLING THE SAME

(71) Applicant: CANON KABUSHIKI KAISHA, Tokyo (JP)

(72) Inventor: Masanao Kurita, Kawasaki-shi (JP)

(21) Appl. No.: 16/149,390

(22) Filed: Oct. 2, 2018

(30) Foreign Application Priority Data
Oct. 5, 2017 (JP) 2017-195375

(51) Int. Cl. G09G 3/00

(52) U.S. Cl. CPC G09G 3/007; G09G 2340/0407; G09G 2340/045

(57) ABSTRACT

A projection apparatus comprises an image display unit configured to modulate light irradiated from a light source according to an input image, a projection unit configured to project light modulated by the image display unit as a projection image, a pixel shifting unit configured to shift a pixel of the projection image, and a conversion unit configured to convert an enlargement magnification in a predetermined direction of the projection image. The pixel shifting unit divides the pixels of the projection image into a predetermined number, and performs a pixel shifting control that shifts the pixels of the projection image based on the divided pixels, and the predetermined number is set according to the enlargement magnification in the conversion unit.

### BACKGROUND OF THE INVENTION

### Field of the Invention

The present invention relates to a technique that converts the aspect ratio of an image and projects the image.

### Description of the Related Art

The number of pixels of image sensors provided in digital cameras continues to increase, and there has been development of video cameras that can capture images in 8K (7680×4320) resolution, and still cameras with a resolution that is several times higher than 8K. Also, it can be assumed that a part of an ultra high resolution image captured with such a high pixel image sensor may be cropped and projected onto a screen by a projector or the like. In a case in which such an ultra high resolution image is cropped according to the shape or size of a subject of the image, the cropped image can have a variety of aspect ratios, such as being longer horizontally or being longer vertically.

In a case in which the aspect ratio of an image is longer horizontally, the use of an anamorphic lens to optically enlarge the horizontal length of a projection image and project the image is a well known technique (Japanese Patent Laid-Open No. 11-316416). Also in the case of horizontally long enlargement and projection by an anamorphic lens, the perceived resolution of the projected image decreases, and therefore there exists a technique that virtually improves the perceived resolution by using a method called pixel shifting (Japanese Patent Laid-Open No. 2011-170008). Pixel shifting uses time division to control the shift of a position of a pixel in the projection image.

However, in a case in which an anamorphic lens is used to optically enlarge and project the projection image, as in the above conventional technique, there are cases in which, depending on the enlargement magnification, the perceived resolution is not improved when pixel shifting control is performed. This tendency becomes prominent in cases in which fractions occur after a decimal point, such as an enlargement magnification of 1.5 times.

### SUMMARY OF THE INVENTION

The present invention has been made in consideration of the aforementioned problems and realizes a technique that can improve the perceived resolution regardless of the enlargement magnification in a case in which the aspect ratio of an image is converted according to an enlargement magnification and the image is projected.

In order to solve the aforementioned problems, the present invention provides a projection apparatus, comprising: an image display unit configured to modulate light irradiated from a light source according to an input image; a projection unit configured to project light modulated by the image display unit as a projection image; a pixel shifting unit configured to shift a pixel of the projection image; and a conversion unit configured to convert an enlargement magnification in a predetermined direction of the projection image, wherein the pixel shifting unit divides the pixels of the projection image into a predetermined number, and performs a pixel shifting control that shifts the pixels of the projection image based on the divided pixels, and the predetermined number is set according to the enlargement magnification in the conversion unit.

In order to solve the aforementioned problems, the present invention provides a control method of a projection apparatus having an image display unit configured to modulate light emitted from a light source according to an input image, and a projection unit configured to project light modulated by the image display unit as a projection image, the method comprising; shifting a pixel of the projection image; and converting an enlargement magnification in a predetermined direction of the projection image, wherein in the shifting of the pixel, the pixels of the projection image are divided into a predetermined number, and pixel shifting control is performed that shifts the pixels of the projection image based on the divided pixels, and the predetermined number is set according to the enlargement magnification in the converting.

In order to solve the aforementioned problems, the present invention provides a non-transitory computer-readable storage medium storing a program for causing a computer to execute a control method of a projection apparatus having an image display unit configured to modulate light emitted from a light source according to an input image, and a projection unit configured to project light modulated by the image display unit as a projection image, the method comprising; shifting a pixel of the projection image; and converting an enlargement magnification in a predetermined direction of the projection image, wherein in the shifting of the pixel, the pixels of the projection image are divided into a predetermined number, and pixel shifting control is performed that shifts the pixels of the projection image based on the divided pixels, and the predetermined number is set according to the enlargement magnification in the converting.

According to the present invention, in a case in which the aspect ratio of an image is converted according to an enlargement magnification and the image is projected, it is possible to improve the perceived resolution regardless of the enlargement magnification.

Further features of the present invention will become apparent from the following description of exemplary embodiments (with reference to the attached drawings).

### BRIEF DESCRIPTION OF THE DRAWINGS

FIG. 1 is a system configuration diagram of an embodiment.

FIG. 2 is a diagram illustrating a method of cropping a part of an image of the present embodiment.

FIG. 3 is a block diagram illustrating a configuration of an image projection apparatus of the present embodiment.

FIG. 4 is a diagram illustrating the relationship between enlargement magnifications and parameters in pixel shifting control of the present embodiment.

FIG. 5 is a diagram illustrating a method of generating a thinned image in the image projection apparatus of the present embodiment.

FIG. 6 is a diagram illustrating a method of virtually generating and projecting pixels by pixel shifting control of the present embodiment.

FIG. 7 is a block diagram illustrating a configuration of an image projection apparatus of the second embodiment.

FIG. 8 is a diagram showing an example of a configuration of a pixel shifting unit of a second embodiment.

FIG. 9 is a diagram illustrating a method of generating a thinned image in an image projection apparatus of the second embodiment.

FIG. 10 is a diagram illustrating a method of virtually generating and projecting pixels by pixel shifting control of the second embodiment.

FIG. 11 is a diagram illustrating a method of generating a thinned image in the image projection apparatus of the second embodiment.

FIG. 12 is a diagram illustrating a method of virtually generating and projecting pixels by a pixel shifting control of a third embodiment.

FIG. 13 is a block diagram illustrating a configuration of an image projection apparatus of the third embodiment.

FIG. 14 is a diagram illustrating a configuration of an aspect ratio conversion unit in the image projection apparatus of the third embodiment.

FIG. 15 is a diagram illustrating the relationship between input image resolution and enlargement magnifications and parameters in pixel shifting control in enlargement processing for the horizontal direction and the vertical direction, in the third embodiment.

### DESCRIPTION OF THE EMBODIMENTS

Embodiments of the present invention will be described in detail below. The following embodiments are merely examples for practicing the present invention. The embodiments should be properly modified or changed depending on various conditions and the structure of an apparatus to which the present invention is applied. The present invention should not be limited to the following embodiments. Also, parts of the embodiments to be described later may be properly combined.

Note that the function blocks described in the present embodiment need not be separate pieces of hardware. In other words, the functions of any number of function blocks may be executed by a single piece of hardware, for example. Also, a function of one function block or the functions of a plurality of function blocks may be executed by the coordinated operation of any number of pieces of hardware. Also, the functions of the function blocks may be executed by a computer program that has been extracted to a memory by a CPU.

### First Embodiment

The following describes an image projection system of a first embodiment.

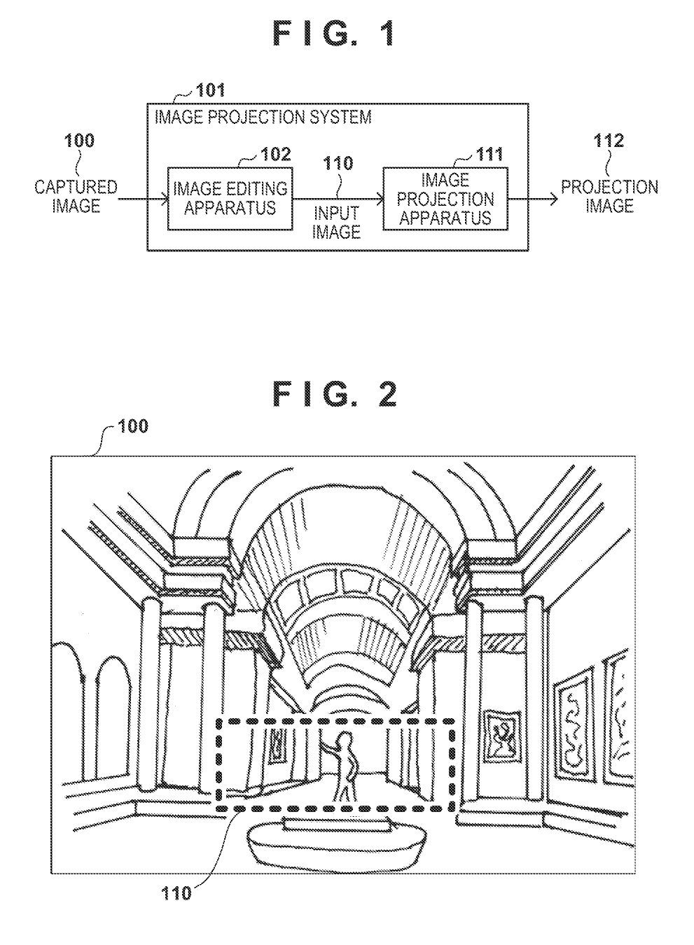

FIG. 1 is a block diagram showing an example of a configuration of an image projection system 101 of the present embodiment.

In FIG. 1, the image projection system 101 of the present embodiment has an image editing apparatus 102 and an image projection apparatus 111. A high resolution captured image 100 that is captured in an image capturing apparatus, such as a digital camera that has a high pixel image sensor, is input to the image projection system 101. The captured image 100 is, for example, assumed to be a 16K image, which is a higher resolution than 8K.

The image editing apparatus 102 has an arithmetic processing device such as a processor, a storage apparatus such as a hard disk, (none of which are shown), and the like. The image processing apparatus performs post production processing such as image selection, unification, character composition, luminance adjustment and color adjustment on the captured image 100 that is input from an external apparatus such as an image capturing apparatus or a PC, and a storage apparatus of the image editing apparatus 102 stores the processed image. Also, the image editing apparatus 102 performs cropping processing according to the shape and size of the main subject, in addition to the post production processing described above. The image that has undergone cropping processing in the image editing apparatus 102 is input to the image projection apparatus 111 as an input image 110, and is projected onto a screen or a wall as a projection image 112. The image projection system 101 of the present embodiment is assumed to have a user such as a business creating or exhibiting an advertisement, or an event planner virtually exhibiting a work of art. An end user is someone who views the projection image.

In the present embodiment, it is possible to improve the perceived resolution of the projection image 112, regardless of the enlargement magnification of the projection image, by performing the previously described pixel shifting control in the image projection apparatus 111 according to the resolution of the input image 110 that was subjected to cropping processing in the image editing apparatus 102.

Here, the cropping method of the input image 110 in the image editing apparatus 102 will be described with reference to FIG. 2. In FIG. 2, the captured image 100 is an image with a resolution of 16K in the horizontal direction and 10K in the vertical direction. For example, a wide angle lens, a fish-eye lens, or the like, is used to capture a wide-range region of the captured image 100 that includes the main subject. Here, a horizontally long image that is 6K in the horizontal direction and 2K in the vertical direction is cropped as the input image 110 in accordance with the intent (user settings) of a user (a person who edits the image). In this case, the vertical and horizontal aspect ratio is 3:1. The resolution and aspect ratio of the input image 110 is appropriately changed according to the captured content of the captured image 100 and the intent of the user. In the present embodiment, the input image 110 is a moving image with a frame frequency of 60 Hz.

Apparatus Configuration

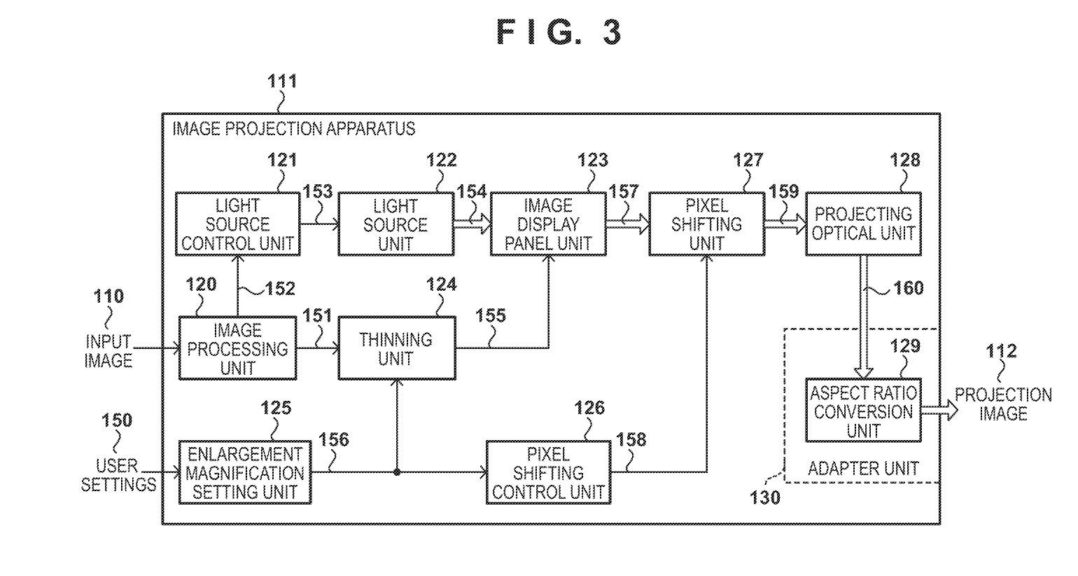

FIG. 3 is a block diagram showing an example of a configuration and the functions of the image projection apparatus ill of the present embodiment.

The image projection apparatus 111 of the present embodiment has a processor, such as a CPU or an MPU (neither shown), and a ROM in which software is stored, as well as a memory, such as a RAM, that is used as a work area. Also, a function of the image projection apparatus 111 is realized by the processor executing a program stored in the ROM.

In FIG. 3, the image projection apparatus 111 has an image processing unit 120, a light source control unit 121, a light source 122, an image display panel unit 123, a thinning unit 124, an enlargement magnification setting unit 125, a pixel shifting control unit 126, a pixel shifting unit 127, and a projecting optical unit 128. Also, the image projection apparatus 111 has an aspect ratio conversion unit 129 that is externally attached to a lens unit of the projecting optical unit 128 as an adapter unit 130. In the present embodiment, the aspect ratio conversion unit 129 has an optical element such as an anamorphic lens.

The input image 110 and user settings 150 are input to the image projection apparatus 111. The input image 110 is input to the image processing unit 120 of the image projection apparatus 111, and subjected to image analysis processing and image quality improvement processing. For example, the calculation of a statistical amount and facial recognition and the like are performed in image analysis processing. Luminance, color, and gamma curve adjustment, noise reduction processing, and the like are performed in image quality improvement processing. Image quality improvement processing is appropriately performed according to the results of the image analysis and the display performance (number of pixels) of the image projection apparatus 111.

An input image signal 151 that has been subjected to image quality improvement processing in the image processing unit 120 is input to the thinning unit 124. Also, a light source control signal 152 corresponding to the calculation results of the luminance statistics in the image processing unit 120 is input from the image processing unit 120 to the light source control unit 121. The light source control signal 152 is a control signal for performing modulation control, such as decreasing the luminance of a light source in a case in which the input image 110 is an image with many dark regions, or increasing the luminance of a light source in a case in which there are many bright regions.

The light source control unit 121 controls the lighting of the light source 122 based on a lighting control signal 153 corresponding to the light source control signal 152, and emits light 154 to the image display panel unit 123. The light 157, which is luminance modulated to a 4K resolution from the image display panel unit 123, is incident on the pixel shifting unit 127, and the light 159 of which pixels have been shifted by the pixel shifting unit 127 is incident on the projecting optical unit 128. A projection image 160 that is output from the projecting optical system 128 becomes the projection image 112 that has been optically enlarged in a predetermined direction in the aspect ratio conversion unit 129.

A super-high pressure mercury lamp, a semiconductor laser, or the like can be used as the light source 122. In a case in which the form of projection is DLP (Digital Light Processing), a DMD (Digital Micromirror Device) can be used as the image display panel unit 123. Also, in a case in which the form of projection is LCOS, a display panel made of a reflective liquid crystal element (liquid crystal on silicon) can be used as the image display panel unit 123.

The user settings 150 are input by a user operating a GUI corresponding to various setting items in a menu screen, for example. Here, the user settings 150 related to enlargement magnification are input to the enlargement magnification setting unit 125. Enlargement magnification is magnification when the projection image 160 is, before projection, optically enlarged and in a predetermined direction in the aspect conversion unit 129 that is attached to the image projection apparatus 111 as the adapter unit 130, and includes values that are not integers (1.5 times or 2.5 times, for example). In a case in which the resolution of the image display panel unit 123 is 4K horizontally and 2K vertically with an aspect ratio of 2:1 and the input image 110 is 6K horizontally and 2K vertically with an aspect ratio of 3:1, the aspect ratio conversion unit 129 with an enlargement magnification of 1.5 times in the horizontal direction is attached. Therefore, 1.5 times in the horizontal direction is input as the user settings 150. The enlargement magnification setting unit 125 outputs enlargement magnification setting information 156 corresponding to the user settings 150 to the thinning unit 124 and the pixel shifting control unit 126. The enlargement magnification setting information 156 is the magnification input by the user settings 150.

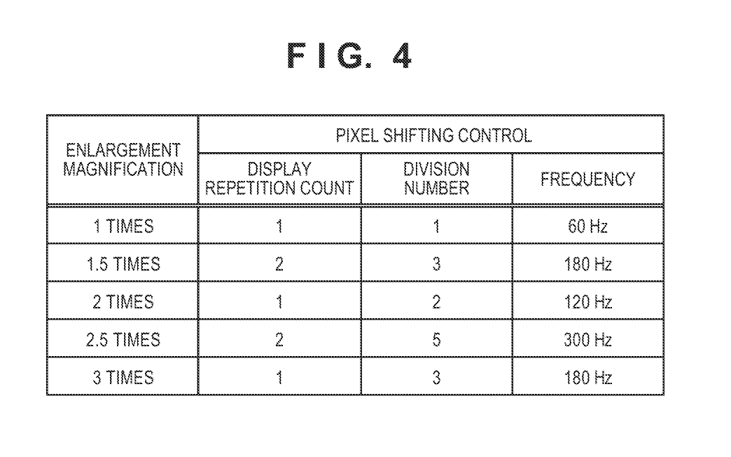

The processing of the pixel shifting control unit 126, the pixel shifting unit 127, the projecting optical unit 128, and the aspect ratio conversion unit 129 in FIG. 3 will be described later in FIGS. 4 to 6 and is briefly described below.

The thinning unit 124 performs thinning processing on the input image signal 151 according to the enlargement magnification setting information 156, and then outputs an image signal 155 that has undergone thinning processing to the image display panel unit 123. The pixel shifting control unit 126 uses a pixel shifting control parameter 158 corresponding to the magnification setting information 156 to control the pixel shifting unit 127. The display of the image display panel unit 123 and the control of the pixel shifting unit 127 are performed in synchronization. The light 154 of the light source 122 is luminance modulated by the image display panel unit 123 and the pixel shifting unit 127, and is projected as the projection image 112 through the projecting optical unit 128 and the aspect ratio conversion unit 129.

Next, the pixel shifting control corresponding to the enlargement magnification in the image projection apparatus 111 of the present embodiment will be described with reference to FIGS. 4 to 6.

FIG. 4 is a diagram illustrating the relationship between the enlargement magnifications and the parameters in the pixel shifting control of the present embodiment.

In FIG. 4, the pixel shifting control parameters include the display repetition count, the division number, and the frequency for each enlargement magnification of the aspect ratio conversion unit 129. The parameters are described in detail later. An enlargement magnification of 1.0 times equates to a case in which pixel shifting control is not performed. The frequency at this time is the same 60 Hz frame frequency of the input image 110. At an enlargement magnification of 1.5 times, the display repetition count of the pixel shifting control is 2, the division number is 3, and the frequency is 180 Hz. The following describes the parameters in the pixel shifting control of the present embodiment.

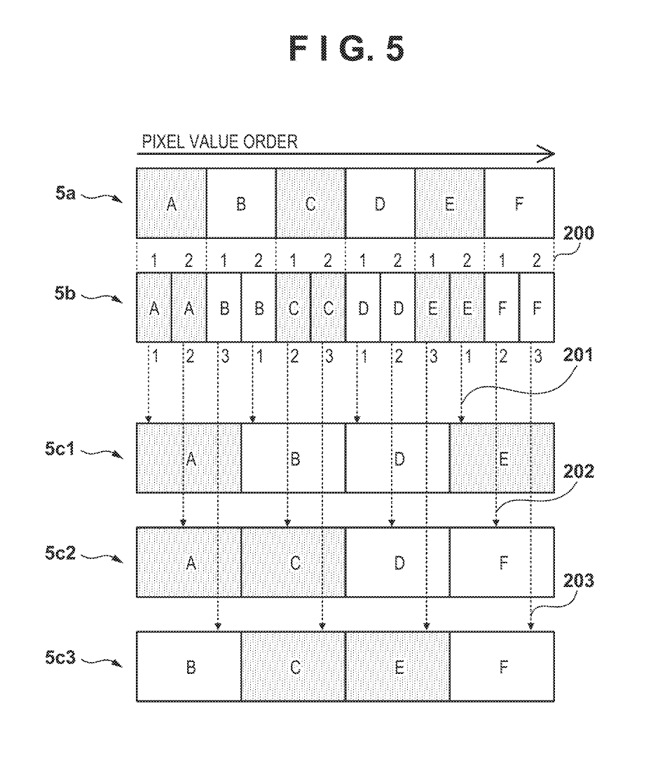

FIG. 5 shows a schematic diagram that illustrates the processing of the thinning unit 124 generating the thinned image 155 in a case in which pixel shifting control is performed. The horizontal axis direction in FIG. 5 corresponds to the order of the pixel values.

Reference numeral 5a of FIG. 5 denotes the pixel values and the order of predetermined frames of the input image signal 151. Note that a part of the input image signal 151 with a resolution of 6K in the horizontal direction is extracted and shown for simplification. The input image signal 151 has a resolution of 6K in the horizontal direction and 2K in the vertical direction, but of these, only six pixels ( 1/1000th) in the horizontal direction and one pixel ( 1/2000th) in the vertical direction are extracted and shown. Here, the pixel values are the six pixels values marked A, B, C, D, E, and F in the horizontal direction. The image display panel unit 123 has a resolution of 4K in the horizontal direction and 2K in the vertical direction, but simply four pixels in the horizontal direction and one pixel in the vertical direction are shown.

As denoted by reference numeral 5b of FIG. 5, processing 200 is performed on the input image signal 151 denoted by reference numeral 5a of FIG. 5 to generate an image signal in which the same pixel values are used to increase the pixel count by 2 times, which is the number (2 in the present example) designated by the display repetition count of the pixel shifting control parameter. Specifically, this is repeated twice for each of the same pixel values A, A, B, B, C, C, etc. Next, the image signal 5b of FIG. 5 is divided by the division number of the pixel shifting control parameters (3 in the present example) and thinning processed sub-frames are generated. Specifically, sub-frame numbers are assigned in order of 1, 2, 3, 1, 2, 3, etc. from the first pixel as shown in reference numeral 5b of FIG. 5, and thinning processing 201 for sub-frame 1, thinning processing 202 for sub-frame 2, and thinning processing 203 for sub-frame 3 are performed. In this way, three sub-frames 1, 2 and 3 denoted by reference numerals 5c1, 5c2 and 5c3 of FIG. 5 are generated. Here, thinning is performed such that four pixels are included in each sub-frame to match the resolution of the image display panel unit 123.

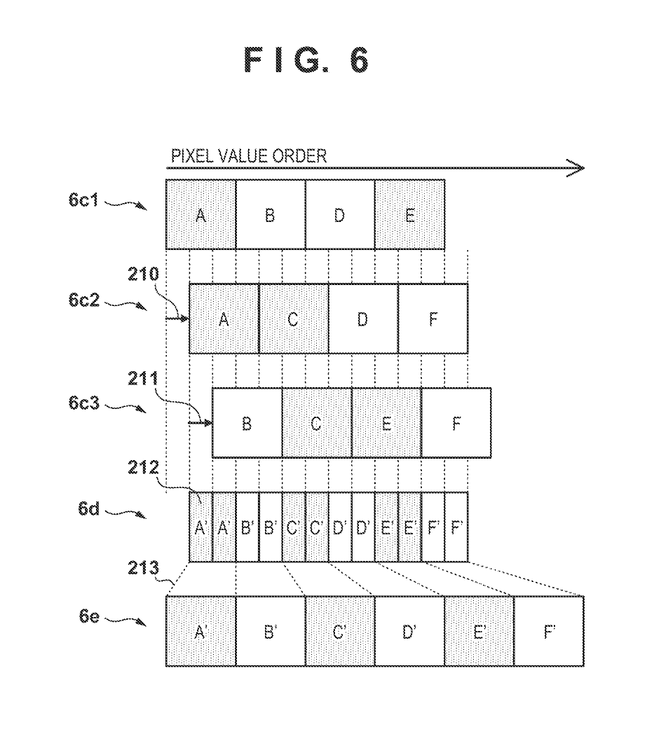

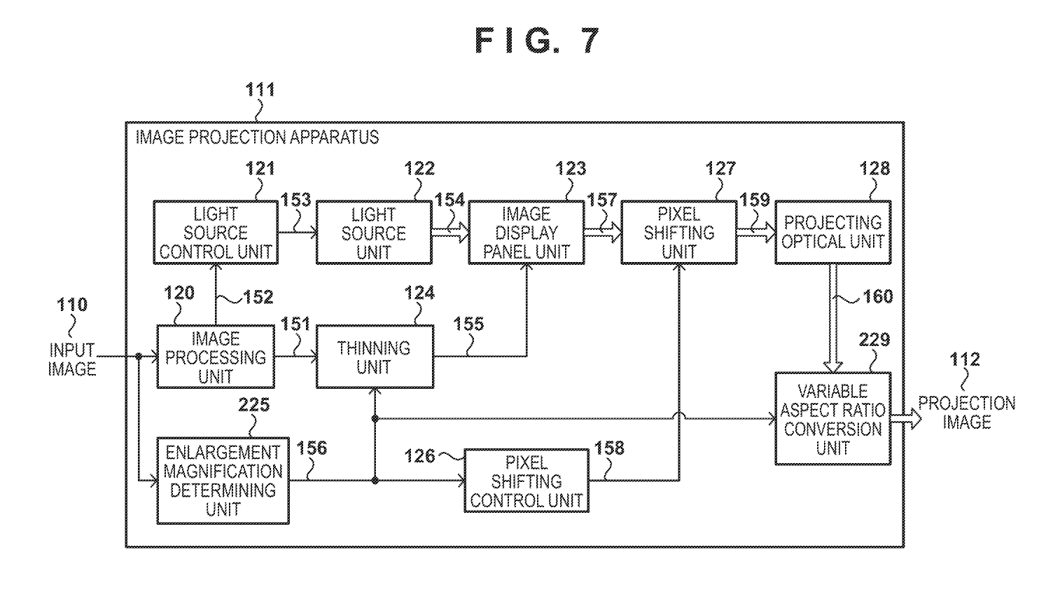

FIG. 6 is a schematic diagram that illustrates the processing in which pixels are virtually generated by pixel shifting control and then projected. The horizontal axis direction of FIG. 6 correspond to the display position and size of pixels.

Reference numerals 6c1, 6c2 and 6c3 of FIG. 6 denote the display pixel positions of sub-frames 1, 2 and 3, which were generated as shown in reference numerals 5c1, 5c2 and 5c3 of FIG. 5, shifted by time division. Reference numeral 6c1 of FIG. 6 denotes sub-frame 1, 6c2 of FIG. 6 denotes sub-frame 2 after pixel position shifting 210 has been performed, and 6c3 of FIG. 6 shows sub-frame 3 after pixel position shifting 211 has been performed. Pixels displayed in the sub-frames are approximately square. The amounts of shift in the pixel position shifting 210 and the pixel position shifting 211 correspond to each pixel being divided into three equal parts. In a case in which they are divided into thirds, the frequency of switching the sub-frames by the pixel shifting control becomes 180 Hz, which is three times the speed of the 60 Hz frequency of the input image 110.

Reference numeral 6d of FIG. 6 shows a schematic diagram showing the pixels that are virtually generated by the pixel shifting control. For example, virtually generated pixels 212 are displayed (seen) by the average of three of the sub-frames, and as shown in reference numeral 6d of FIG. 6 are displayed by an average value A′ of three pixel values, A, A, and X. X is any pixel value that is not displayed in the diagrams. The average value A′ is generally approximate to the pixel value A. The next virtually generated pixels are displayed in the same manner as the average value A′ and arranged in the order of A′ of B′, B′, C′, C′, etc. following that. These virtually generated pixels become vertically longer pixels that are one third the size in the horizontal direction.

Reference numeral 6e of FIG. 6 denotes pixels after which the aspect conversion unit 129 has performed enlargement processing 213 of 1.5 times in the horizontal direction. When the vertically long pixels A′, A′, B′, B′, C′, C′, etc., that are one third the size in the horizontal direction, are enlarged by 1.5 times, square pixels A′, B′, C′, etc. are generated, and it can be understood that the input image signal 151 denoted by reference numeral 5a of FIG. 5 is being virtually projected. In other words, the perceived resolution is better than the resolution of the image display panel unit 123.

The following describes a method of calculating the pixel shifting control parameters shown in FIG. 4. The following is an example of program code that calculates the pixel shifting control parameters. The program code is written in the C programming language. When an enlargement magnification a is input, a pixel shifting division number b is determined such that it is a value that is evenly divisible by the enlargement magnification a. The pixel shifting display repetition count is the quotient when the pixel shifting division number b is divided by the enlargement magnification a.

As described above, by applying the pixel shifting control of the present embodiment, in a case in which projection is performed after enlargement in a predetermined direction by the aspect ratio conversion unit, it is possible to improve the perceived resolution with the pixel shifting control regardless of the enlargement magnification.

Parameter Calculation Program

```
/************************************/
#include <stdio.h>
int main (void)
{
      float a; //enlargement magnification
      float b; //pixel shifting division number
      int n; //pixel shifting display repetition count
      /* input enlargement magnification */
      printf (“please input enlargement magnification¥n”);
      scanf(”%f”, &a);
      /* calculate pixel shifting division number */
      for (n=1; n<=10; n++) { // Make the maximum display repetition
count 10 times
            b = a * n;
            if(!(b−(int)b)){ //Set the division number b to a value that
is evenly divisible by the enlargement magnification.
                  break;
            }
            }
      /* Show result */
            printf (“when enlargement magnification is %f¥n”, a);
      printf (“pixel shifting division number is %d¥n”, (int)b);
      printf (“pixel shifting repetition count is %d¥n”, n);
      return 0;
}
/************************************/
```

### Second Embodiment

The first embodiment describes a configuration in which the enlargement magnification is input by the user settings 150. The present embodiment describes a configuration in which the enlargement magnification is more flexibly changeable, and the pixel shifting control is switched automatically. For example, it is conceivable that there is a method of usage in which the captured image 100 is a moving image and the enlargement magnification can be dynamically changed when the scene changes.

FIG. 7 is a block diagram showing an example of a configuration and the functions of the image projection apparatus 111 of the present embodiment.

The image projection apparatus 111 of the present embodiment has an enlargement magnification determining unit 225 instead of the enlargement magnification setting unit 125 of FIG. 3, and a variable aspect ratio conversion unit 229 instead of the aspect ratio conversion unit 129 as the adapter unit 130. The variable aspect ratio conversion unit 229 is incorporated in the image projection apparatus 111. Because other configurations and functions are the same as in FIG. 3, the same reference numerals are used and their descriptions are omitted.

In FIG. 7, the enlargement magnification determining unit 225 automatically sets the enlargement magnification according to the resolution of the input image 110. For example, in a case in which the resolution of the input image 110 is 8K in the horizontal direction and 2K in the vertical direction with an aspect ratio of 4:1, the enlargement magnification is set to 2.0 times in the horizontal direction in accordance with the resolution (4K in the horizontal direction and 2K in the vertical direction) of the image display panel unit 123. Specifically, the 8K horizontal resolution of the input image 110 is divided by the 4K horizontal resolution of the image display panel unit 123, and 2.0 times is calculated as the enlargement magnification. For example, in a case in which the resolution of the input image 110 is 10K in the horizontal direction and 2K in the vertical direction with an aspect ratio of 5:1, the enlargement magnification is set to 2.5 times in the horizontal direction in accordance with the resolution (4K in the horizontal direction and 2K in he vertical direction) of the image display panel unit 123.

The enlargement magnification setting information 156 is calculated by the enlargement magnification determining unit 225 and is set. The enlargement magnification setting information 156 is input to the variable aspect ratio conversion unit 229, as well as the thinning unit 124 and the pixel shifting control unit 126. The variable aspect ratio conversion unit 229 has a plurality of prism elements, and the aspect ratio (enlargement magnification) is changed by adjusting the arrangement angle between the prism elements.

The pixel shifting control unit 126 uses a pixel shifting control parameter 158 corresponding to the magnification setting information 156, and controls the pixel shifting unit 127. Specifically, the division number in the pixel shifting control parameters displayed in FIG. 4 of the first embodiment is dynamically changed and controlled.

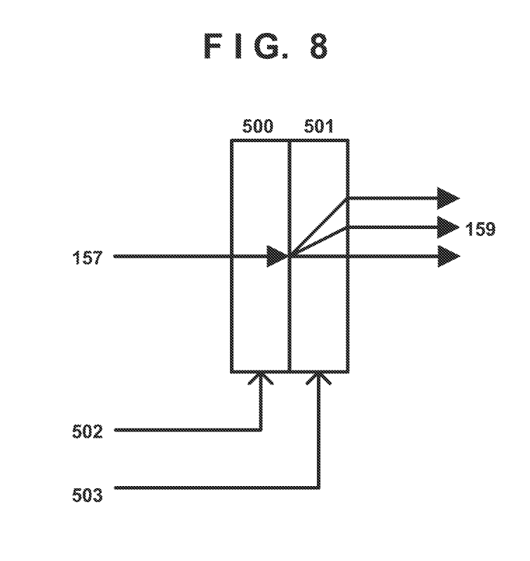

FIG. 8 is a schematic diagram showing an example of a configuration of the pixel shifting unit 127 of the second embodiment. The pixel shifting unit 127 is configured by bonding a liquid crystal panel 500 to a birefringence element 501. Light 157 that is luminance modulated to a resolution of 4K from the image display panel unit 123 is incident on the liquid crystal panel 500, and the linear polarization direction of the light 157 is switched based on a liquid crystal signal 502. The birefringence element 501 can spatially shift (shift pixel positions) emitted light 159 according to the linear polarization direction of the light 157. A control voltage 503 is applied to the birefringence element 501, and the Pockels effect in which the refractive index of the birefringence element 501 changes according to the control voltage 503 is used, making it possible to change the division number in the pixel shifting control.

The following describes thinned image generation and pixel shifting control in cases in which the enlargement magnification is 2.0 times and 2.5 times.

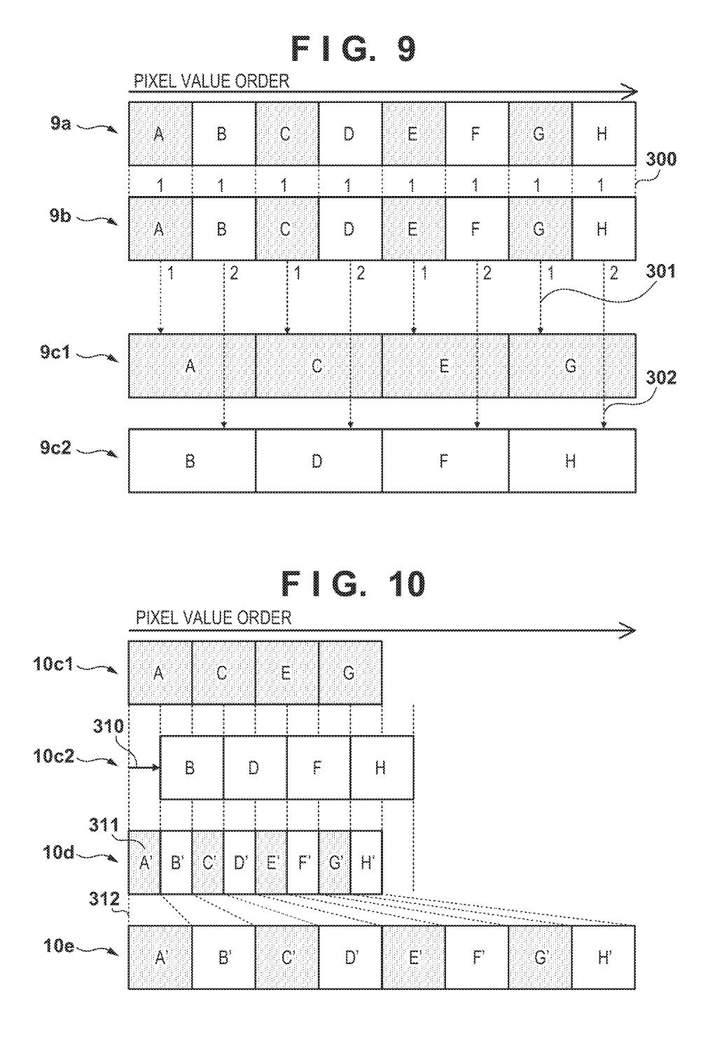

First, pixel shifting control in a case in which the enlargement magnification is 2.0 will be described with reference to FIGS. 9 and 10. As shown in FIG. 4, in a case in which the enlargement is 2.0 times, pixel shifting control is performed with the display repetition count being 1, the division number being 2 and the frequency being 120 Hz.

FIG. 9 is a schematic diagram that illustrates the process of the thinning unit 124 generating the thinned image 155 in a case in which pixel shifting control is performed. The horizontal axis direction in FIG. 9 corresponds to the order of pixel values.

Reference numeral 9a of FIG. 9 denotes the pixel values and the order of the predetermined frames of the input image signal 151. Note that a part of the input image signal 151 with a resolution of 8K in the horizontal direction is extracted, and shown for simplification. The input image signal 151 has a resolution of 8K in the horizontal direction and 2K in the vertical direction, but of these, only eight pixels ( 1/1000th) in the horizontal direction and one pixel ( 1/2000th) in the vertical direction are extracted and shown. Here, the pixel values are the eight pixel marked A, B, C, D, E, F, G, and H in the horizontal direction. The image display panel unit 123 has a resolution of 4K in the horizontal direction and 2K in the vertical direction, but simply four pixels in the horizontal direction and one pixel in the vertical direction are shown.

As shown in reference numeral 9a of FIG. 9, processing 300 is performed on the input image signal 151 to generate an image signal in which the same pixel values are used to increase the pixel count by 1 time, which is the number (1 in the present example) designated by the display repetition count of the pixel shifting control parameter. The display repetition count in the present example is 1, so the pixel counts denoted by reference numerals 9a and 9b of FIG. 9 do not change. Next, the image signal 9b of FIG. 9 is divided by the division number of the pixel shifting control parameters (2 in the present example) and thinning processed sub-frame is generated. Specifically, sub-frame numbers are assigned in order from the first pixel as shown in reference numeral 9b of FIG. 9, which is 1, 2, 1, 2, 1, 2, etc., and a thinning processing 301 for sub-frame 1, a thinning processing 302 for sub-frame 2 is performed. In this way, two sub-frames 1 and 2 denoted by reference numerals 9c and 9c2 of FIG. 9 are generated. Here, thinning is performed such that four pixels are included in each sub-frame to match the resolution of the image display panel unit 123.

FIG. 10 shows a schematic diagram that illustrates the processing in which pixels are virtually generated by pixel shifting control and then projected. The horizontal axis direction of FIG. 10 correspond to the display positions and sizes of pixels.

Reference numerals 10c1 and 10c2 of FIG. 10 denotes sub-frames in which sub-frames 1 and 2 generated as shown in reference numerals 9c1 and 9c2 of FIG. 9 have had their displayed pixel positions shifted by time division. Reference numeral 10c1 of FIG. 10 denotes sub-frame 1, and 10c2 of FIG. 10 shows sub frame 2 after pixel position shift 310 has been performed. Pixels displayed in the sub-frames are approximately square. The amounts of shift of the pixel position shifting 310 and the pixel position shifting 311 correspond to each pixel being divided into two equal parts. In a case of division into halves, the frequency of switching the sub-frames by the pixel shifting control becomes 120 Hz, which is two times the speed of the 60 Hz frequency of the input image 110.

Reference numeral 10d of FIG. 10 shows a schematic diagram showing the pixels that are virtually generated by the pixel shifting control. For example, virtually generated pixels 311 are displayed (seen) by the average of the two sub-frames, and as shown in reference numeral 6d of FIG. 6 are shown by an average value A′ of two pixel values (A, and X). X is any pixel value that is not displayed in the diagrams. The average value A′ is generally approximate to the pixel value A. In a case in which the values of the pixel value A and the pixel value X are distant from each other, the similarity becomes lower, but in many natural images adjoining pixels have values that are close. In the same manner of thinking, the next virtually generated pixel is displayed by the average value B′ of the pixel values A and B. The pixel values are then arranged in the order of C′, D′, E′, F′, etc. These virtually generated pixels become the vertically long pixels that are one half the size in the horizontal direction.

Reference numeral 10e of FIG. 10 denotes pixels that have undergone enlargement processing 312 at 2.0 times the horizontal direction by the variable aspect ratio conversion unit 229. When the vertically long pixels A′, B′, C′, D′, E′, F′, etc. which are one half the size of the horizontal direction are enlarged by 2.0 times, the square pixels A′, B′, C′, D′, E′, F′, etc. are arranged, and it can be understood that the input image signal 151 denoted by reference numeral 9a of FIG. 9 is being virtually projected. In other words, the perceived resolution is better than the resolution of the image display panel unit 123.

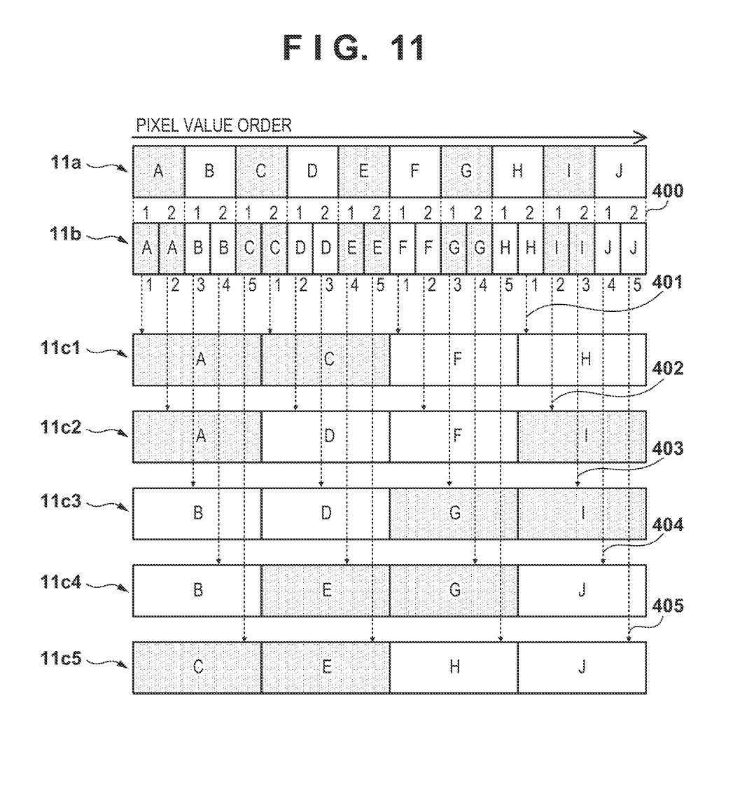

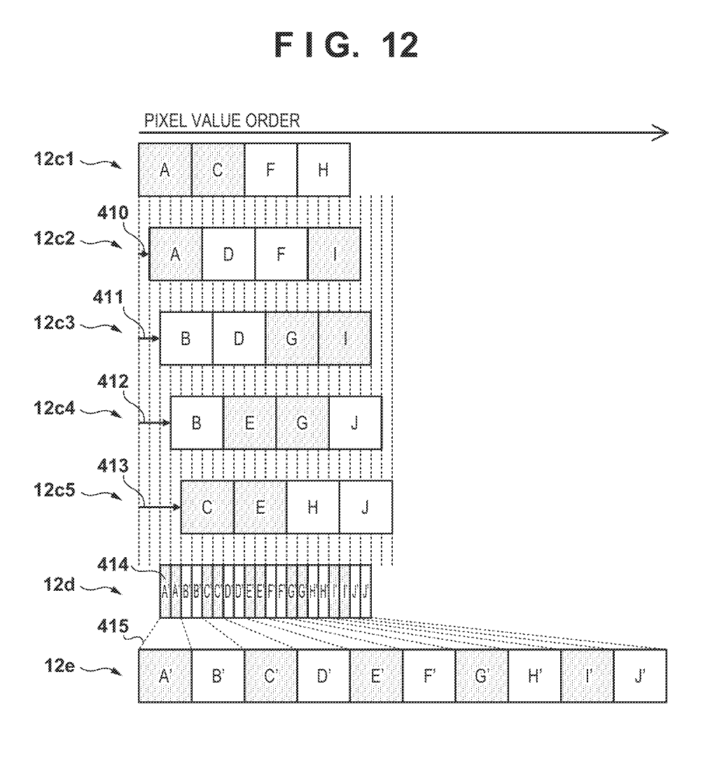

Next, pixel shifting control in a case in which the enlargement magnification is 2.5 times is described with reference to FIGS. 11 and 12. As shown in FIG. 4, in a case in which the enlargement magnification is 2.5 times, pixel shifting control is performed with the display repetition count being 2, the division number being 5 and the frequency being 300 Hz. In this way, in a case in which the pixel shifting control is performed with a high frequency, it is favorable to use a DMD panel capable of high speed display for the image display panel unit 123.

FIG. 11 shows a schematic diagram that illustrates the process of generating the thinning image 155 by the thinning unit 124 in a case in which the pixel shifting control is performed. The horizontal axis direction in FIG. 11 corresponds to the order of the pixel values.

Reference numeral 11a of FIG. 11 denotes the pixel values and the order of predetermined frames of the input image signal 151. Note that, a part of the input image signal 151 with a resolution of 10K in the horizontal direction is extracted, for simplification and shown. The input image signal 151 has a resolution of 10K in the horizontal direction and 2K in the vertical direction, but only ten ( 1/1000) pixels in the horizontal direction and one ( 1/2000) pixel in the vertical direction are extracted and shown. Here, the pixel values are the ten pixel values in the horizontal direction marked A, B, C, D, E, F, G, H, I, and J. The image display panel unit 123 has a resolution of 4K in the horizontal direction and 2K in the vertical direction, but simply four pixels in the horizontal direction and one pixel in the vertical direction are shown.

As shown in reference numeral 11b of FIG. 11, processing 400 to generate an image signal in which the same pixel values are used to increase the pixel count by 2 times, which is the number (2 in the present example) designated by the display repetition count of the pixel shifting control parameters is performed on the input image signal 151 denoted by reference numeral 11a of FIG. 11. Specifically, the same pixel values are used to generate two of each pixel value, A, A, B, B, C, C, etc. Next, the image signal 11b of FIG. 11 is divided by a division number of the pixel shifting control parameters (5 in the present example) and a thinning processed sub-frame is generated. Specifically, sub-frame numbers are assigned in order of 1, 2, 3, 4, 5, 1, 2, 3, 4, 5, etc. from the first pixel as shown in reference numeral 11b of FIG. 11, and then thinning processing 401 for sub-frame 1, thinning processing 402 for sub-frame 3, thinning processing 403 for sub-frame 3, thinning processing 404 for sub-frame 4, and thinning processing 405 for sub-frame 5 are performed. In this way, the five sub-frames 11c1 to 11c5 of FIG. 11 are generated. Here, thinning is performed such that four pixels are included in each sub-frame to match the resolution of the image display panel unit 123.

FIG. 12 shows a schematic diagram that illustrates the processing in which pixels are virtually generated by pixel shifting control and then projected. The horizontal axis direction of FIG. 12 corresponds to the display position and size of pixels.

FIG. 12 shows the display pixel positions of five sub-frames 11c1 to 11c5, which are generated in FIG. 11, shifted by time division. Sub-frame 1 is shown in reference numeral 12c1 of FIG. 12, and reference numeral 12c2 of FIG. 12 denotes sub-frame 2 after pixel position shifting 410 is performed. Subsequently, the pixel position shifting 411 to 413 is performed in the same manner, and sub-frames 3 to 5 are displayed. Pixels displayed in the sub-frames are approximately square. The pixel position shifting 410 to 413 corresponds to each pixel being divided into five equal parts. In a case of division into fifths, the frequency at which the sub-frames are switched by the pixel shifting control is 300 Hz, which is five times the speed of the 60 Hz frequency of the input image 110.

Reference numeral 12d of FIG. 12 shows a schematic diagram showing pixels virtually generated by the pixel shifting control. For example, virtually generated pixels 414 are displayed (seen) by the average of the five sub-frames, and as shown in reference numeral 12d of FIG. 12 are shown by the average value A′ of five pixel values A, A, B, X, and X. X is any pixel value that is not displayed in a diagram. The average value A′ is generally approximate to the pixel value A. In a case in which the values of pixel value A and pixel value X are distant from each other, the similarity becomes lower, but in many natural images adjoining pixels have values that are close. In the same manner of thinking, the next virtually generated pixel is displayed by the average value B′ of five pixel values A, A, B, B, and X. The pixel values are then arranged in the order of B′, B′, C′, C′, D′, D′, etc. These virtually generated pixels become vertically long pixels that are one fifth of the size in the horizontal direction.

Reference numeral 12e of FIG. 12 denotes the pixels to which the enlargement processing 415 at 2.5 times the horizontal direction has been performed by the variable aspect ratio conversion unit 229. When the vertically long pixels A′, A′, B′, B′, C′, C′, etc., that are one fifth the size in the horizontal direction are enlarged by 2.5 times, the square pixels A′, B′, C′, etc. are generated, and it can be understood that the input image signal 151 denoted by reference numeral 11a of FIG. 11 is being virtually projected. In other words, the perceived resolution is better than the resolution of the image display panel unit 123.

As described above, in a case in which the variable aspect ratio conversion unit performs enlargement in a predetermined direction before projection, it is possible to improve the perceived resolution by the pixel shifting control regardless of the enlargement magnification by automatically switching the image shifting control according to the enlargement magnification.

### Third Embodiment

The present embodiment describes a configuration in which the pixel shifting unit and the aspect ratio conversion unit collectively form a replaceable unit, and the projecting optical unit is a replaceable unit.

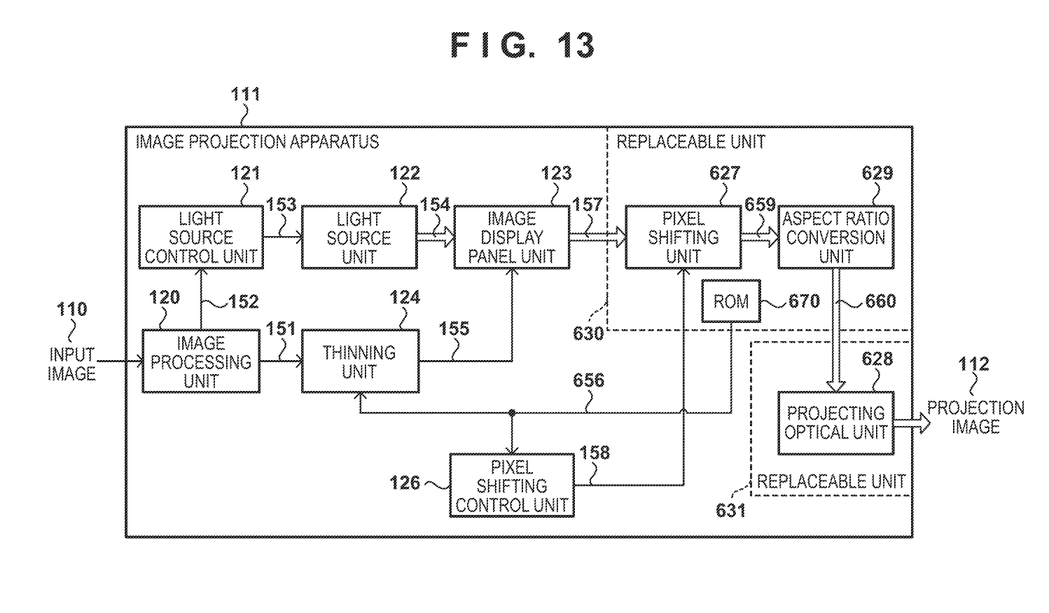

FIG. 13 is a block diagram showing an example of a configuration and the functions of the image projection apparatus 111 of the present embodiment.

The image projection apparatus 111 of the present embodiment omits the enlargement magnification setting unit 125 of FIG. 3 and the enlargement magnification determining unit 225 of FIG. 7. Also, the image projection apparatus ill of the present embodiment has a pixel shifting unit 627 and a aspect ratio conversion unit 629 as a replaceable unit 630, and a projecting optical unit 628 as a replaceable unit 631. The replaceable units 630 and 631 can be selected by a user according to an intended use and attached and detached to and from the image projection apparatus 111. Other configurations and functions are the same as in FIG. 3 and FIG. 5, and therefore similar configurations have the same reference numerals and will not be described.

The replaceable unit 630 includes the pixel shifting unit 627, the aspect ratio conversion unit 629, and a ROM 670. When the replaceable unit 630 is mounted to the image projection apparatus 111, the pixel shifting unit 627 is connected to the pixel shifting control unit 126 via electrical contacts (not shown), and the ROM 670 is connected to the thinning unit 124 via electrical contacts (not shown) and the pixel shifting control unit 126.

By the pixel shifting unit 627 and the aspect ratio conversion unit 629 together forming one of the replaceable units 630, the pixel shifting control of the pixel shifting unit 627 and the enlargement processing of the aspect ratio conversion unit 629 can be performed inside a single unit. The replaceable unit 630 can, for example, be replaced such that the enlargement magnification is a 1.0 times to 2.0 times lens, or a 2.0 times to 3.0 times lens, according to the range of the enlargement magnification that the user wants to use. Also, magnification setting information 656 that is currently set by the aspect ratio conversion unit 629 is written to the ROM 670. The magnification setting information 656 that is written to the ROM 670 is read by the thinning unit 124 and the pixel shifting control unit 126 via electrical contacts (not shown) and is used for various processing.

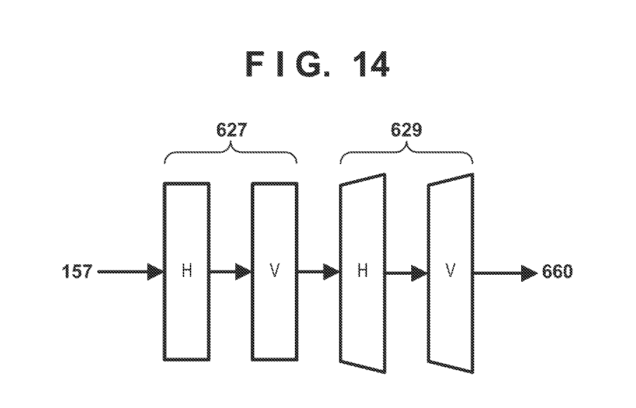

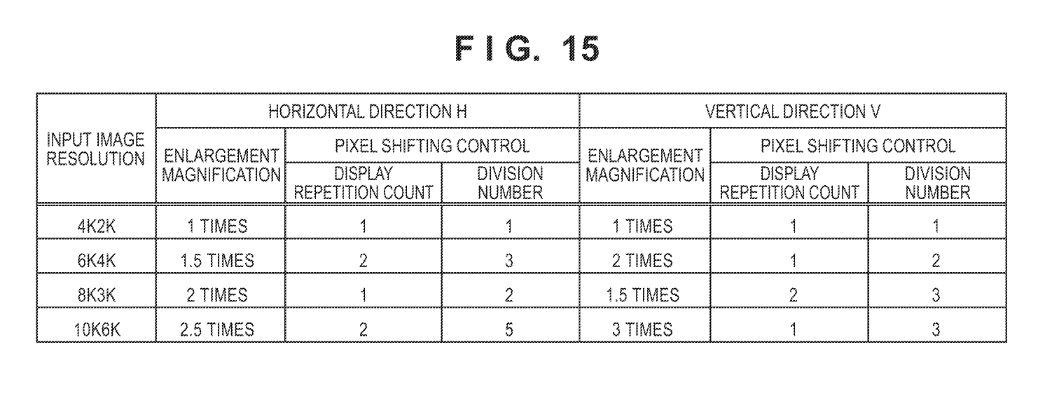

In the previously described first and second embodiments, enlargement processing is only performed in the vertical direction, but in the present embodiment, it is possible to apply a replaceable unit that has an aspect ratio conversion unit which performs enlargement processing in the horizontal direction and the vertical direction. FIG. 14 illustrates a configuration of the pixel shifting unit and the aspect ratio conversion unit. The light 157 is luminance modulated to a resolution of 4K in the image display panel unit 123, is incident on the pixel shifting unit 627 of the replaceable unit 630, becomes the light 659 that shifts pixels in the horizontal (H) direction and the vertical (V) direction, becomes the projection image 660 that is optically enlarged in the horizontal (H) direction and the vertical (V) direction in the aspect ratio conversion unit 629, and the projection image 112 is output from the projecting optical unit 628 of the replaceable unit 631.

FIG. 15 is a diagram illustrating the relationship between the enlargement magnification and the parameters in the pixel shifting control and the resolution of the input image, in the enlargement processing of the horizontal direction and the vertical direction by the variable aspect ratio conversion unit of the present embodiment. In a case in which the resolution of the input image is 4K/2K, the enlargement magnification in the horizontal direction and the vertical direction is 1.0 times each, and the pixel shifting control is not performed. In a case in which the input image resolution is 6K/4K, the enlargement magnification in the horizontal direction is 1.5 times, and the enlargement magnification in the vertical direction is 2.0 times. The parameter calculation program of the first embodiment can be used to obtain the pixel shifting control parameters in the enlargement magnification in the horizontal direction and the vertical direction. The ability to perform enlargement in the horizontal direction and the vertical direction is favorable for an intended use which requires flexibility of the aspect ratio, such as projection mapping, displaying advertisements on a wall, for example.

Returning to FIG. 13, the replaceable unit 631 includes the projecting optical unit 628. For example, it is possible to select a replaceable unit that includes a projecting optical system that has a short lens, a zoom lens, or the like in accordance with the distance to the projection screen or object.

As described above, by the pixel shifting unit 627 and the aspect ratio conversion unit 629 being constituted as the replaceable unit 630, it is possible to change to a unit according to the range of the enlargement magnification that the user wants to use. Also, in a case of enlargement and projection in a predetermined direction by the aspect ratio conversion unit 629, it is possible to improve the perceived resolution by the pixel shifting control, regardless of the enlargement magnification.

In the embodiments described above, the aspect ratio conversion units 129, 229 and 629 are provided in the image projection apparatus 111, but it is possible to apply these to an image capturing apparatus that generates the captured image 100. By capturing an image with an anamorphic lens or the like, an image in which the aspect ratio has been optically converted (compressed) is captured. In the present embodiment, pixel shifting processing is performed according to the resolution or the like of the input image 110 cropped in the image editing apparatus 102 but a configuration is conceivable in which pixel shifting processing is performed with consideration given to the optical enlargement magnification at the time of image capture. For example, in the case of using an anamorphic lens that performs 1.5 times compression at the time of image capture, pixel shifting control for enlargement by the same 1.5 times may be performed.

Also, in the previously described embodiments, pixel shifting control and pixel shifting control parameter calculation are executed in the image projection apparatus 111, but a configuration is possible in which the image editing apparatus 102 or another external apparatus transmits a control command that includes pixel shifting control parameters to the image projection apparatus 111, and the image projection apparatus 111 performs pixel shifting control based on those control commands.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2017-195375 filed Oct. 5, 2017 which is hereby incorporated by reference herein in its entirety.

What is claimed is:

1. A projection apparatus, comprising:
an image display unit configured to modulate light irradiated from a light source according to an input image;
a projection unit configured to project light modulated by the image display unit as a projection image;
a pixel shifting unit configured to shift a pixel of the projection image; and
a conversion unit configured to convert an enlargement magnification in a predetermined direction of the projection image,
wherein the pixel shifting unit divides the pixels of the projection image into a predetermined number, and performs a pixel shifting control that shifts the pixels of the projection image based on the divided pixels, and
the predetermined number is set according to the enlargement magnification in the conversion unit.

2. The apparatus according to claim 1, further comprising
a thinning unit configured to perform thinning processing on the input image according to the predetermined number,
wherein the pixel shifting unit performs the pixel shifting control on an image that was subjected to the thinning processing.

3. The apparatus according to claim 1, wherein the predetermined number is a value that is divisible by the enlargement magnification.

4. The apparatus according to claim 3, wherein the enlargement magnification includes a number that is not an integer.

5. The apparatus according to claim 1, further comprising a control unit configured to control the pixel shifting unit based on the predetermined number.

6. The apparatus according to claim 5, wherein the control unit sets a frequency of switching of the projection image on which the pixel shifting control was performed by the pixel shifting unit, according to the enlargement magnification in the conversion unit.

7. The apparatus according to claim 1, wherein the pixel shifting unit performs the pixel shifting control based on a control command that includes the predetermined number and was transmitted from an external apparatus.

8. The apparatus according to claim 1, wherein the pixel shifting unit performs the pixel shifting control in the same direction as the predetermined direction in which the conversion unit enlarges the projection image.

9. The apparatus according to claim 8, wherein the conversion unit converts the enlargement magnification in a direction different from the predetermined direction in the projection image.

10. The apparatus according to claim 1, wherein the pixel shifting unit comprises an element that refracts the light modulated by the image display unit to shift a direction of exit.

11. The apparatus according to claim 1, wherein the pixel shifting unit and the conversion unit are configured as one replaceable unit.

12. The apparatus according to claim 11, wherein the replaceable unit includes a storage unit configured to store information related to the enlargement magnification of the conversion unit.

13. The apparatus according to claim 11, wherein the projection unit is configured as a replaceable unit.

14. The apparatus according to claim 1, wherein the enlargement magnification of the conversion unit is set according to a user setting.

15. The apparatus according to claim 1,
wherein the enlargement magnification of the conversion unit can be changed, and
the enlargement magnification is set based on a resolution of the input image.

16. A control method of a projection apparatus having an image display unit configured to modulate light emitted from a light source according to an input image, and a projection unit configured to project light modulated by the image display unit as a projection image, the method comprising;
shifting a pixel of the projection image; and
converting an enlargement magnification in a predetermined direction of the projection image,
wherein in the shifting of the pixel, the pixels of the projection image are divided into a predetermined number, and pixel shifting control is performed that shifts the pixels of the projection image based on the divided pixels, and
the predetermined number is set according to the enlargement magnification in the converting.

17. A non-transitory computer-readable storage medium storing a program for causing a computer to execute a control method of a projection apparatus having an image display unit configured to modulate light emitted from a light source according to an input image, and a projection unit configured to project light modulated by the image display unit as a projection image, the method comprising;
shifting a pixel of the projection image; and
converting an enlargement magnification in a predetermined direction of the projection image,
wherein in the shifting of the pixel, the pixels of the projection image are divided into a predetermined number, and pixel shifting control is performed that shifts the pixels of the projection image based on the divided pixels, and
the predetermined number is set according to the enlargement magnification in the converting.
